(19) United States
(12) Patent Application Publication
(10) Pub. No.: US 2012/0056923 A1
(43) Pub. Date: Mar. 8, 2012

(54) CONTROL SYSTEMS AND METHODS FOR THERMAL-JET PRINTING

(75) Inventors: Eliyahu Vronsky, Los Altos, CA (US); Valerie Gassend, San Carlos, CA (US); Dariusz Golda, Redwood City, CA (US); Hyeun-Su Kim, Palo Alto, CA (US)

(73) Assignee: KATEEVA, INC., Menlo Park, CA (US)

(21) Appl. No.: 13/219,515

(22) Filed: Aug. 26, 2011

Related U.S. Application Data
(63) Continuation-in-part of application No. 12/580,831, filed on Oct. 16, 2009.
(60) Provisional application No. 61/142,575, filed on Jan. 5, 2009.
(60) Provisional application No. 61/509,042, filed on Jul. 18, 2011.

(51) Int. Cl. B41J 29/38

(52) U.S. Cl. 347/12; 347/14

(57) ABSTRACT

Embodiments of methods and apparatus for micro-printing films are disclosed. According to various embodiments, the printing apparatus includes printheads with ink-jets for dispensing droplets of ink formed from a carrier liquid and a print material. The printheads also include thermal-jets for depositing the print material onto a substrate from the droplets of ink dispensed by ink-jets. The droplets of ink dispensed by ink-jets flow into micro-structures on the thermal-jets and the thermal-jets are heated to evaporate the carrier liquid and to vaporize and direct the print material onto a substrate. The printing apparatus further includes a control unit that is configured to automatically adjust an output from one or more printheads based on one or more measured quantities.

### RELATED APPLICATION

This application is a Continuation-in-Part Application of the co-pending U.S. patent application Ser. No. 12/580,831, titled “METHOD AND APPARATUS FOR CONTROLLING THE TEMPERATURE OF AN ELECTRICALLY-HEATED DISCHARGE NOZZLE”, filed Oct. 16, 2009, which claims priority under 35 U.S.C. 119 (e) of the U.S. Provisional Patent Application Ser. No. 61/142,575, filed Jan. 5, 2009, and titled “METHOD AND APPARATUS FOR CONTROLLING THE TEMPERATURE OF AN ELECTRICALLY-HEATED DISCHARGE NOZZLE”. This patent application also claims priority under 35 U.S.C. 119 (e) of the U.S. Provisional Patent Application Ser. No. 61/509,042, filed Jul. 18, 2011, and titled “CONTROL SYSTEMS AND METHOD FOR THERMAL-JET PRINTING”. The co-pending U.S. patent application Ser. No. 12/580,831, titled “METHOD AND APPARATUS FOR CONTROLLING THE TEMPERATURE OF AN ELECTRICALLY-HEATED DISCHARGE NOZZLE”, filed Oct. 16, 2009, the U.S. Provisional Patent Application Ser. No. 61/142,575, filed Jan. 5, 2009, and titled “METHOD AND APPARATUS FOR CONTROLLING THE TEMPERATURE OF AN ELECTRICALLY-HEATED DISCHARGE NOZZLE” and the U.S. Provisional Patent Application Ser. No. 61/509,042, filed Jul. 18, 2011, and titled “CONTROL SYSTEMS AND METHOD FOR THERMAL-JET PRINTING” are all hereby incorporated by reference.

### FIELD OF THE INVENTION

The present teachings relate to systems for and methods of micro-printing or depositing micro-patterns of materials onto substrates. More specifically, the present teachings relate to control systems for and methods of micro-printing or depositing micro-patterns of materials onto substrates using thermal-jet printing techniques.

### BACKGROUND OF THE INVENTION

New methods for making displays have emerged in response to the enormous increase in demand for electronic devices that have display capabilities. Most displays used in electronic devices are light-emitting diode displays (LEDs), Electroluminescent displays (ELDs), Plasma display panels (PDPs), Liquid crystal displays (LCDs) or Thin-film transistor displays (TFTs). Of the emerging display technologies, organic light-emitting diode displays (OLEDs) appears to be the most promising.

OLEDs are generally formed from a layer of electroluminescence organic material. Usually the electroluminescence organic material includes electrically conductive molecules that have delocalized electrons. In operation the delocalized electrons populate a high energy or excited state when the layer of electroluminescence organic material is placed within an electrical field. When electrical field is removed, the delocalized electrons relax to low energy or ground states and emit light.

OLEDs have a number of potential advantages over other types of displays technologies. OLEDs are likely to cost less to produce in the future and can be formed on a variety of different substrates, including flexible substrates. OLEDs potentially have a greater contrast, use less power and have faster refresh rates than other displays. While OLEDs have shown great promise for replacing more conventional displays, currently they can be difficult to make and manufacture with consistent quality and performance using conventional techniques.

### SUMMARY OF THE INVENTION

Various aspects of the present teachings are directed to testing and control methods for micro-printing or depositing micro-patterns of materials onto substrates, e.g., as with a printing apparatus. In various embodiments, the printing apparatus includes a printhead. The print head can include a dispensing mechanism for dispensing droplets of ink. The dispensing mechanism can be, for example, a thermal ink-jet, a piezoelectric ink-jet, or a combination thereof.

The ink can comprise a carrier fluid and film-forming, or print, material. For example, the ink can comprise a carrier liquid comprising an organic solvent or a mixture of organic solvents. For example, a suitable carrier liquid can include acetone, chloroform, isopropanol, chlorobenzene, toluene, or combinations thereof. The print material includes one or more electroluminescence organic materials that is dissolved into the carrier liquid or forms a suspension or emulsion with the carrier liquid. Electroluminescence organic materials include, for example, pentacene, aluminum tris-(8-hydroxyquinoline) (AlQ₃), N,N-diphenyl-N,N-bis(3-methylphenyl)-(1,1′-biphenyl)-4,4′-diamine (TPD), bathocuproine (BCP), fac tris(2-phenylpyridine) iridium (Irppy), and combinations thereof.

In addition to the carrier liquid and one or more electroluminescence organic materials, such as described above, inks can also include any number of different materials for tailoring the rheology, electrical and/or mechanical properties of the inks and the films that are formed using the inks. For example, inks can include polymeric materials, surfactants, metals, organo-metallics, nano-particles or any number of other organic and inorganic materials. Various aspects of inks are described, for example, in U.S. Publication No. 2008/0311289 A1 titled “METHOD AND APPARATUS FOR CONTROLLING FILM DEPOSITION,” the contents of which are hereby incorporated by reference.

While films produced employing the inks and methods described herein can be used for making OLEDs, the inks and methods of the present teachings also have applications for making any number of thin layer devices including, but not limited to, circuits, transistors, photo-detectors, solar cells, chemical sensors, etc.

The printing apparatus of the present teachings can include, according to various embodiments, a thermal-jet for receiving droplets of ink. The thermal-jet includes a discharge nozzle and a heating element. The discharge nozzle can be formed from anodized aluminum oxide, silicon or any other suitable material or combination of materials. The discharge nozzle is patterned with micro-structures that have micron or sub-micron dimensions. The micro-structures are, for example, micro-pores and/or micro-channels arranged in a pattern. The micro-structures pass through the discharge nozzle, partially pass through the discharge nozzle, extend partially into the discharge nozzle, or a combination thereof. Details of micro-structures and micro-structure patterns are described in U.S. Publication No. 2008/0311307 A1 titled “METHOD AND APPARATUS DEPOSITING FILMS,” the contents of which are hereby incorporated by reference.

The heating element, according to various embodiments, is configured to cycle the discharge nozzle through a heating profile that deposits the print material of the ink onto a suitable substrate (e.g. glass). For example, the heating element heats the discharge nozzle to remove or evaporate the carrier liquid from the ink within the micro structures and further heats the discharge nozzle to a temperature that is sufficient to cause the print material to escape or vaporize from the micro-structures and adhere to or condense onto a substrate that is in close proximity to the discharge nozzle to thereby produce a printed image or pixel on the substrate.

In accordance with various embodiments of the present teachings, the printing apparatus of the present teachings includes a control unit for controlling the printhead based on at least one measured quantity. The measured quantity comprises, for example, a calibrated temperature or heating profile of the heating element, sizes of ink droplets that are dispensed from the dispensing mechanism, quality of a printed image and/or analysis of a test pattern printed using the printhead.

In the case where the measured quantity comprises the temperature or heating profile of the heating element, the control unit measures the resistance of the heating element and/or the discharge nozzle against a standard resistance, referred to herein as R₀, and adjusts voltage applied to the heating element such that the heating profile comports to a standardized heating profile based on R₀. Where the measured quantity includes sizes of ink droplets, the printing apparatus includes a strobe-light and a camera for measuring the sizes of the ink droplets. In operation, the control unit adjusts an input, such as voltage, applied to the dispensing mechanism to control the sizes of the ink droplets. Where the measured quantity comprises the quality of a printed image and/or analysis of a test pattern, the apparatus includes an optical detection system or optical hardware for determining print thickness, print coverage and/or pattern locations. In operation the control unit adjusts the temperature or heating profile of the heating element or discharge nozzle, sizes of the ink droplets and/or alignment of the printhead with the substrate based on the measured quality of a printed image or test pattern. Analyses described above, are performed while the print apparatus is in operation or alternatively as a diagnostic procedure performed before a printing process begins. The measurements are invasive or non-invasive depending on the type of tools used to measure the quantity. For example, in some embodiments generating a test pattern and analyzing the test pattern can involve removal of the printed image from the printing apparatus and result in degradation of the material printed.

The print apparatus of the present invention can include one or more printhead arrays. The printhead arrays are, for example, mounted on an automated printing drum. Each print head array includes a homogeneous grouping of printheads or a heterogeneous grouping of print heads. Further, each of the printhead arrays is the same or is different depending on the application at hand and the intended outcome.

### BRIEF DESCRIPTION OF THE DRAWINGS

FIG. 1 is a schematic representation of a printing apparatus including a printhead and a control unit, in accordance with various embodiments of the present teachings.

FIG. 2 is a schematic representation of a printing apparatus including a printhead, a control unit, a strobe-light and a camera, in accordance with various embodiments of the present teachings.

FIG. 3 is a schematic representation of a printing apparatus including a printhead, a control unit and an optical detection system, in accordance with various embodiments of the present teachings.

FIG. 4 is a schematic representation of a test pattern used to measure print quality, in accordance with various embodiments of the present teachings.

FIG. 5 shows a schematic representation of a printing apparatus comprising a printhead array, in accordance with various embodiments of the present teachings.

FIGS. 6A-D are block-flow diagrams outlining steps for controlling printheads of a printing apparatus, in accordance with various embodiments of methods of the present teachings.

FIG. 7 is a schematic representation of a printing apparatus comprising printhead arrays mounted to an automated drum, in accordance with various embodiments of the present teachings.

### DETAILED DESCRIPTION

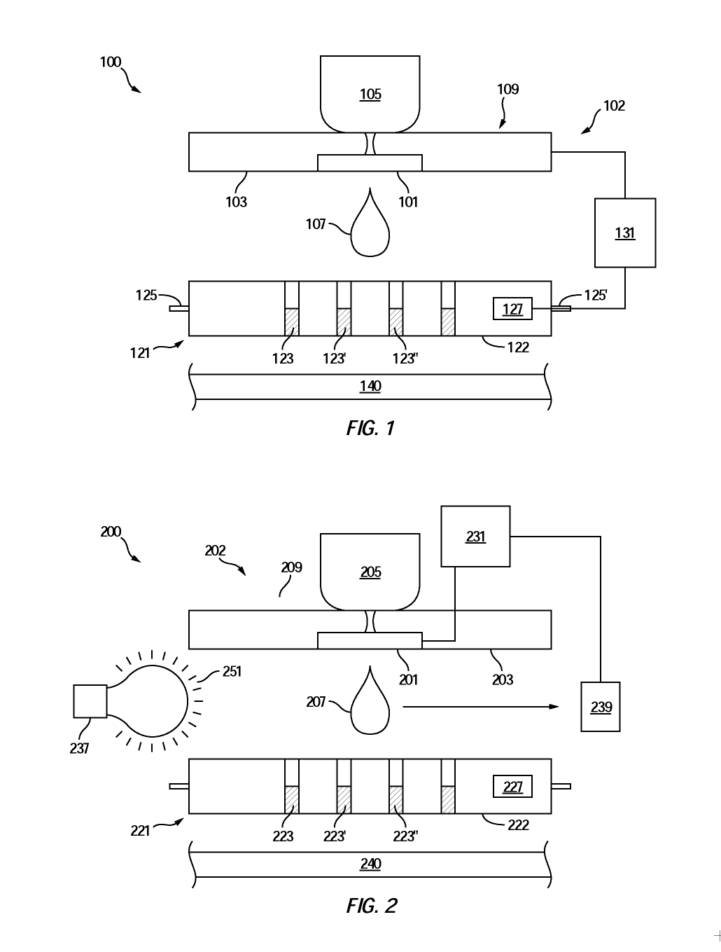

Referring to FIG. 1, various aspects of the present teachings are directed to a printing apparatus, such as printing apparatus 100 that includes a printhead 102. The printhead 102 includes a dispensing mechanism 109 for dispensing droplets of ink 107. The dispensing mechanism 109 can be an ink-jet with support structure 103, a controlled dispensing nozzle 101 and an ink reservoir 105 coupled to the controlled dispensing nozzle 101.

The printhead 102 further includes a thermal-jet 121 with a discharge nozzle 122 and heating element 127. The discharge nozzle 122 is formed from any suitable material or combination of materials, such as described above and is patterned with micro-structures 123, 123′ and 123″. The thermal-jet 121 is positioned in proximity with the dispensing mechanism 109 for receiving the droplets of ink 107, such that ink enters the micro-structures 123, 123′ and 123″, as indicated by the hatching within the micro-structures 123, 123′ and 123″.

The micro-structures 123, 123′ and 123″ are micro-pores or micro-channels that pass through the discharge nozzle 122 or partially pass through the discharge nozzle 122 or a combination thereof. In various embodiments, micro-structures 123, 123′ and 123″ partially pass through the discharge nozzle 122. Such micro-structures are sometimes referred to as blind pores. The micro-structures 123, 123′ and 123′ are uniform in shape and size or include a range of shapes and sizes depending on the application at hand and the intended outcome. Where the micro-structures 123, 123′ and 123″ partially pass through the discharge nozzle 122, the thermal-jet 121 can be rotated through hinge features 125 and 125′ prior to printing a pattern onto a substrate 140. The printing apparatus 100 can include an enclosure or environmental chamber (not shown) for isolating the dispensing mechanism 109, the thermal-jet 121, the substrate 140 or portions thereof within a controlled environment (e.g., an environment at or slightly above one atmosphere in pressure, and comprising gaseous nitrogen).

The heating element 127 is configured to cycle the discharge nozzle 122 through a temperature or heating profile. The temperature or heating profile is a step-shaped profile, a wave-shaped profile, a linear-shaped profile or any other profile that removes or evaporates carrier liquid from the ink within the micro-structures 123, 123′ and 123″ and causes the remaining print material to escape or vaporize from the micro-structures 123, 123′ and 123″ and be deposited onto the substrate 140. In some cases the vaporization involves sublimation.

In accordance with various embodiments of the present teachings, the printing apparatus 100 further includes a control unit 131 for controlling the printhead 102 based on a measured quantity. The measured quantity is, for example, the resistance of the heating element 127. The control unit 131 then adjusts the heating element 127 in order to obtain a desired temperature profile based on look-up tables, algorithms and/or other computing tools. In other words, the method maps temperature with resistance of the heating element 127. In some cases the temperature of the heating element 127 is controlled by adjusting a voltage or waveform applied to the heating element.

Because heating element resistances may vary with design of the thermal-jet heating elements, and in order to properly map temperature with resistance, a lookup table is created for each heating element design. Temperature can be measured with, for example, an infrared microscope that records temperatures at different values of resistance of a heating element. The lookup table translates a temperature set-point into a resistance value that processed by electronics to control the heating element. Because there is resistance variation from heating element of a particular design, an additional calibration step is performed for each individual heating element of the same design.

The reference resistance R₀, at some set temperature T₀, is measured. For each heating element, the reference resistance R₀ is provided to the software as an input. The lookup table is executed by software relating the temperature to the ratio of the resistance of the heater to its reference resistance (R/R₀). For a given temperature waveform, the software can output the corresponding resistance waveform using the reference resistance value and the lookup table and the control unit 131 can thereby control the heating element to the desired temperature.

Referring now to FIG. 2, in various embodiments a printing apparatus 200 includes a printhead 202 with an ink-jet 209. The ink-jet 209 includes a support structure 203 and a controlled dispensing nozzle 201 coupled to an ink reservoir 205. The ink reservoir 205 is coupled to the controlled dispensing nozzle 201 for dispensing droplets of ink 207, such as described above. The printhead 202 further includes a thermal-jet 221 with a discharge nozzle 222 patterned with micro-structures 223, 223′ and 223″ for receiving the droplets of ink 207 into micro-structures 223, 223′ and 223″ and a heating element 227 for cycling the discharge nozzle 222 through a temperature profile to deposit a print material from the ink onto a substrate 240.

In accordance with various embodiments of the present teachings, the printing apparatus 200 further includes a strobe light 237 and a camera 239 for measuring sizes of the droplets of ink 207 dispensed from the ink-jet 209 using radiation 251 emitted by the strobe light 237. For example, the printing apparatus 200 includes a commercially available strobe light 237 and a camera 239 which can be configured to measure ink drop volume, ink drop velocity and ink drop trajectory.

The printing apparatus 200 further includes a control unit 231 that is coupled to the camera 239, the strobe light 237 and the controlled dispensing nozzle 201 of the ink-jet. The control unit 231 includes a computer (not shown) that executes software code to determine the sizes of the droplets of ink 207. In operation, when the control unit 231 determines that the sizes of the droplets of ink 207 are outside of the intended range, the control unit 231 adjusts the controlled dispensing nozzle 201 of the ink-jet 209 to change the sizes of the sequential droplets of ink that are dispensed. The control unit can also adjust the rates that the sequential droplets of ink are dispensed at. In some embodiments the controlled dispensing nozzle 201 of the ink-jet 209 is adjusted by changing a voltage applied to controlled dispensing nozzle 201 and/or a pulse shape of the voltage applied to controlled dispensing nozzle 201.

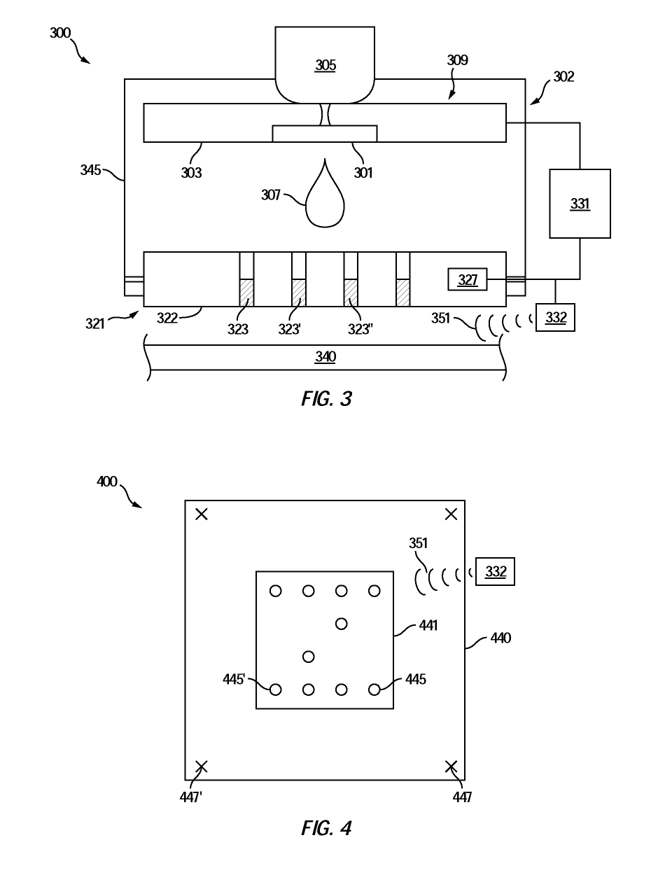

Referring now to FIG. 3, in various embodiments a printing apparatus 300 includes a printhead 302 with an ink-jet 309. The ink-jet 309 includes a support structure 303 and a controlled dispensing nozzle 301 coupled to an ink reservoir 305. As described above, the reservoir 305 is coupled to the controlled dispensing nozzle 301 for dispensing droplets of ink 307. The printhead 302 further includes a thermal-jet 321 with a discharge nozzle 322 patterned with micro-structures 323, 323′ and 323″ for receiving the droplets of ink 307 into micro-structures 323, 323′ and 323″ and a heating element 327 for cycling the discharge nozzle 322 through a temperature profile to deposit a print material from the ink onto a substrate 340. The printing apparatus 300 can include an enclosure or environmental chamber 345 for isolating the ink-jet 309, the thermal-jet 321, the substrate 340 or portions thereof.

In accordance with various embodiments of the present teachings, the printing apparatus 300 further includes a detection system 332 for measuring a print thickness, a print coverage and/or pattern locations. The detection system 332 may be a non-contact detection optical system, such as a spectrophotometer. Alternatively, or in addition, the detection system 332 may be a contact profilometer for measuring deposited film thickness. Whether the detection system 332 uses contact detection or non-contact detection methods, the detection system 322 includes a computer (not shown) with software that includes look-up tables and algorithms for determining print thickness, print coverage and/or pattern locations based on signals 351 detected by the detection system 332.

The printing apparatus 300 further includes a control unit 331 that is coupled to the ink-jet 309 and/or the heating element 327 of the thermal-jet 321. In operation, the detection system 332 determines print thickness, print coverage and/or pattern locations and the control unit adjusts the temperature profile of the heating element 327 sizes of ink droplets of ink dispensed by the ink-jet 309 and/or alignment of the printhead to achieve a controlled print thickness, print coverage and/or pattern location of print material on the substrate 340.

Where the detection system 332 determines pattern locations or pattern shapes from the signals 351, the printing apparatus 300 can generate a test pattern 400, such as shown in FIG. 4. The test pattern 400 can include, for example, a pattern of print material 445 and 445′ on a print area 441 of a substrate 440. The test pattern 400, in accordance with various embodiments of the present teachings, includes alignment marks 447 and 447′. In operation, the detection system 332 analyzes the test pattern 400 and based on locations of the test pattern determines alignment of the printhead 302 with the substrate 340. When the detection system 332 determines that printhead 302 is out of alignment with the substrate 340, the control unit 331 automatically adjusts the printhead 302 to align with the substrate 340. The detection system 332 in accordance with various embodiments of the present teachings can make measurements during a printing process or after a printing process. However, due to the spatial constraints between the thermal-jet 321 and the substrate 340 (e.g., which in various embodiments are separated by a distance of 200 micrometers or less, and in some embodiments 100 micrometers or less), the detection system is not typically making measurements while the thermal-jet 321 and the substrate 340 are in direct alignment.

The test pattern 400 may be generated with varying print thickness, such that analysis of the test pattern and thicknesses of the various areas of the test pattern can be used to determine the performance of ink-jets and/or thermal-jets of the printhead 302. Also, the test pattern 400, in accordance with various embodiments of the present teachings, is used to determine if one or more ink-jets or thermal jets of the printhead 302 has failed and needs refurbishment or replacement.

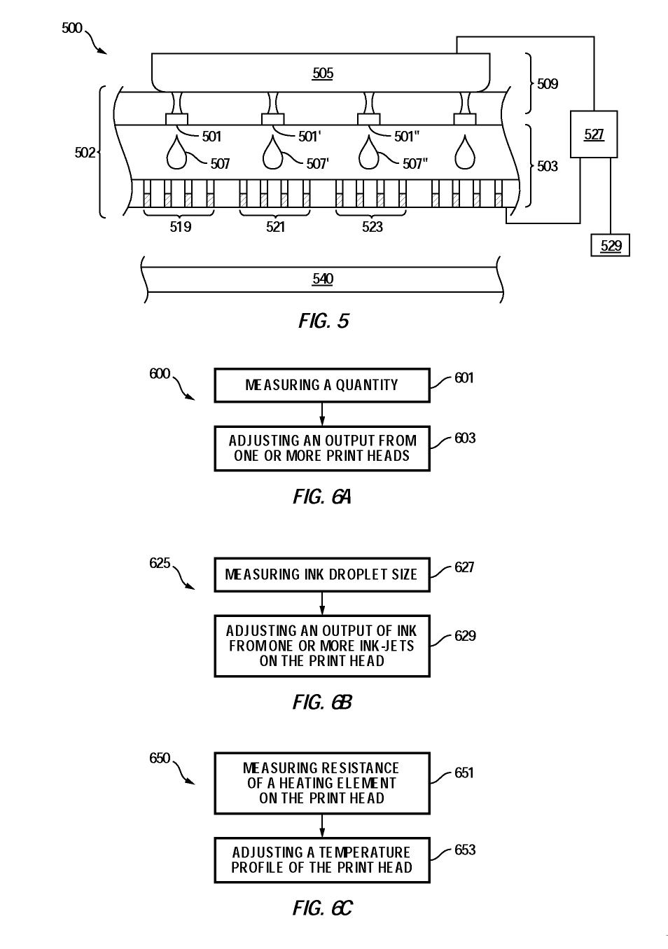

Referring now to FIG. 5, according to various embodiments, a printing apparatus 500 of the present teachings can include a printhead 502 with an ink-jet portion 509 having a plurality of controlled dispensing nozzles 501, 501′ and 501″. The controlled dispensing nozzles 501, 501′ and 501″ are coupled to separate ink reservoirs (not shown) or a shared ink reservoir 505 for dispensing the same type and size of droplets of ink or different types and sizes of droplets of ink. The printhead 502 further includes a thermal-jet portion 503 with a plurality of discharge nozzles 519, 521 and 523 patterned with micro-structures, such as described above. In operation the micro-structures receive droplets of ink 507, 507′ and 507″ and one or more heating elements (not shown) cycle the thermal-jet portion 503 through a temperature or heating profile to deposit print material from the droplets of ink 507, 507′ and 507″ onto a substrate 540. The printhead configuration shown in FIG. 5 is referred to herein as a printhead array. The printhead array 502 has the same kind of dispensing nozzles 501, 501′ and 501″ and discharge nozzles 519, 521 and 523 (i.e., is a homogeneous printhead array). Alternatively, the printhead array 502 has different kinds of dispensing nozzles 501, 501′ and 501″ and/or discharge nozzles 519, 521 and 523 (i.e., is a heterogeneous printhead array). Regardless of whether the print-head array 502 is a homogenous printhead array or heterogeneous printhead array, the printing apparatus 500 can include a control unit 527 and/or an optical detection system 529, such as described above with reference to FIGS. 1-3. The control unit 527 and/or an optical detection system 529 are configured to automatically adjust temperature or heating profiles of discharge nozzles 519, 521 and 523, the sizes of the ink droplets 507, 507′ and 507″, alignment of the printhead array 502 with the substrate 540, or any combination thereof.

FIGS. 6A-D are block-flow diagrams outlining the steps for controlling a printing apparatus, in accordance with various embodiments of methods of the present teachings. Referring to the block-flow diagram 600 in FIG. 6A, in the step 601a quantity is measured from a printing apparatus, such as described above. After the quantity is measured from the printing apparatus in the step 601, in the step 603 an output of one or more printheads is adjusted based on the quantity measured in the step 601. Referring now to the block-flow diagram 625 in FIG. 6B, in the step 627 the quantity measured from the printing apparatus comprises sizes of droplets of ink. After the sizes of droplets of ink are measured in the step 627, in the step 629 an output of ink from one or more corresponding ink-jets on the printhead is adjusted. Referring now to the block-flow diagram 650 in FIG. 6C, in the step 651 resistance of one or more heating elements on a thermal jet of printhead is measured. After the resistance of one or more heating elements on a thermal jet of printhead is measured in the step 651, in the step 653 a temperature profile of the one or more of the heating elements is adjusted with reference to R₀.

Now referring to the block-flow diagram 675 shown in FIG. 6D, in the step 677 print quality of an image printed from a printhead is measured. After the print quality of the image printed from the printhead is measured in the step 677, in the step 679 one or more of sizes of droplets of ink dispensed from an ink-jet portion of the printhead, a heating profile of a thermal-jet portion of the printhead and/or alignment of the printhead is adjusted. In accordance with various embodiments of the present teachings, prior to measuring the print quality of an image printed from a printhead in the step 677, in the step 676 a test pattern, such as shown in FIG. 4, is generated from the printhead and is then used for analyzing the print quality of the printhead in the step 677.

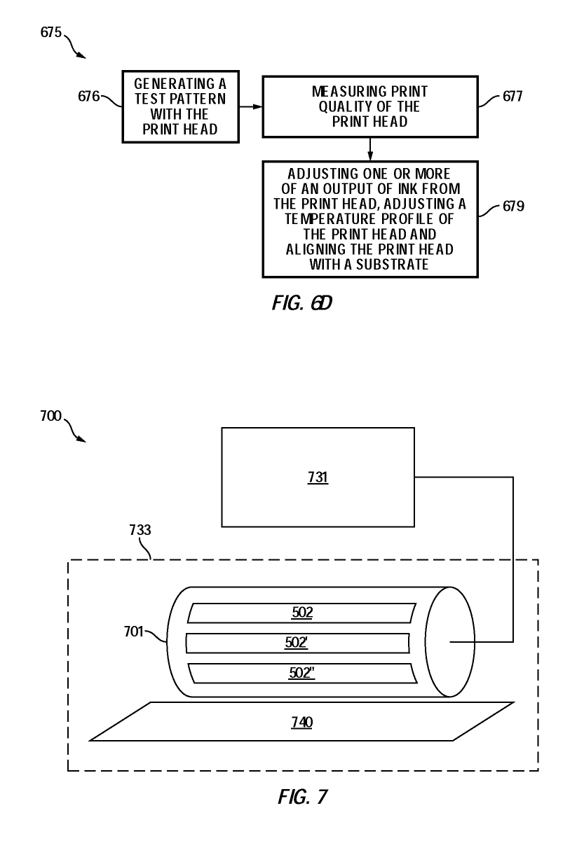

FIG. 7 shows a schematic representation of a printing apparatus 700 with printhead arrays 502, 502′ and 502″ mounted to automated printing drum 701, in accordance with various embodiments of the present teachings. The printhead arrays 502, 502′ and 502″ are all the same or alternatively two or more are different. Also, each of the printhead arrays 502, 502′ and 502″ are homogeneous printhead arrays or heterogeneous printhead arrays depending on the application at hand and the intended outcome. Each of the printhead arrays 502, 502′ and 502″ include ink-jet portions and thermal-jet portions, such as described above with reference to FIG. 5. The automated printing drum 701 can be contained within and environmental chamber 733. In operation the printhead arrays 502, 502′ and 502″ sequentially print a print material from an ink onto a substrate 740 as the automated printing drum 701 rotates each of the printhead arrays 502, 502′ and 502″ to be proximal with the substrate 740. As described above, the printing apparatus 700 also includes a control unit 731 with circuitry, computers, software and/or optical hardware to adjust and control the printhead arrays 502, 502′ and 502″ and/or the automated printing drum 701 based on one or more measurements of sizes of ink droplets dispensed by the ink-jet portions, heating profiles of heating elements of the thermal-jet portions and/or print quality of the printhead arrays 502, 502′ and 502″.

Aspects of the present teachings can be practiced, for example, in connection with the teachings of US patent publication numbers US2008/0311307, US2006/0115585, US2010/0188457, US2011/0008541, US2010/0171780, and US2010/0201749, as well as U.S. patent application numbers Ser. No. 12/954,910, Ser. No. 61/439,816, Ser. No. 61/453,098, Ser. No. 61/473,646, and Ser. No. 61/480,327; each incorporated herein by reference.

The present teachings have been described in terms of various embodiments to facilitate the understanding of the principles of construction and operation of the present teachings. References herein to specific embodiments and details thereof are not intended to limit the scope of the claims appended hereto. It will be apparent to those skilled in the art that modifications can be made in the embodiments chosen for illustration without departing from the spirit and scope of the present teachings.

What is claimed is:

1. A printing apparatus comprising:
a) a dispensing mechanism for dispensing droplets of ink comprising a carrier liquid and a print material;
b) a thermal-jet comprising one or more micro-structures for receiving the droplets of ink from the dispensing mechanism;
c) a heating element thermally coupled to the thermal-jet for heating the thermal-jet through a temperature profile that evaporates the carrier liquid from the ink and vaporizes the print material from the micro-structures, directing the vaporized print material onto a substrate to produce a printed image;
d) at least one sensor configured to measure at least one quantity associated with said printing apparatus; and
e) a control unit for controlling the print head based on the at least one measured quantity by said at least one sensor.

2. The printing apparatus of claim 1, wherein the measured quantity comprises resistance of the heating element and, wherein the control unit is adapted to control the temperature profile.

3. The printing apparatus of claim 1, wherein the measured quantity comprises a size of the ink droplets and, wherein the control unit is adapted to control an amount of ink dispensed.

4. The printing apparatus of claim 3, further comprising a camera and a strobe light for determining sizes of the ink droplets.

5. The printing apparatus of claim 1, wherein the measured quantity comprises image quality of the printed image and, wherein the control unit is adapted to control one or more of the temperature profile and an amount of ink dispensed.

6. A printing apparatus comprising:
a) a plurality of ink-jets for dispensing droplets of ink comprising a carrier liquid and a print material;
b) a plurality of thermal-jets including micro-structures for receiving the droplets of ink, wherein each thermal jet is configured to heat through a temperature profile for evaporating the carrier liquid from the ink and for vaporizing the print material from the micro-structures and directing the vaporized print material onto a substrate to produce a printed image;
c) at least one sensor configured to measure at least one quantity associated with said printing apparatus; and
d) a control unit for selectively controlling the printed image based on at least one quantity measured by said at least one sensor.

7. The printing apparatus of claim 6, wherein the measured quantity comprises resistance of heating elements coupled to the thermal jets and, wherein the control unit is adapted to selectively control the temperature profiles of the thermal jets.

8. The printing apparatus of claim 6, wherein the measured quantity comprises size of the ink droplets and, wherein the control unit is adapted to selectively control an amount of ink comprising the ink droplets.

9. The printing apparatus of claim 8, further comprising a camera and a strobe light for determining sizes of the ink droplets.

10. The printing apparatus of claim 6, wherein the measured quantity comprises a test pattern on the printed image and, wherein the control unit is adapted to align one or more of the printheads with the substrate.

11. A method of controlling a printed image from a printing apparatus based on at least one measured quantity, the method comprising:
a) measuring the at least one quantity; and
b) adjusting an output from one or more printheads of the printing apparatus based on the at least one measured quantity, wherein the printing apparatus includes;
i) an ink-jet portion for dispensing droplets of ink comprising a carrier liquid and a print material; and
ii) a thermal-jet portion including micro-structures for receiving the droplets of ink, wherein the thermal jet is configured to heat through a temperature profile for evaporating the carrier liquid from the ink within the micro-structures and for vaporizing the print material from the micro-structures and directing the vaporized print material onto a substrate to produce the printed image.

12. The method of claim 11, wherein said measuring comprises measuring sizes of the droplets of ink.

13. The method of claim 11, wherein said measuring comprises measuring a temperature of the thermal-jet portion.

14. The method of claim 11, wherein said measuring comprises measuring a test pattern on the printed image.

15. The method of claim 11, wherein said measuring comprises measuring a layer thickness of the printed image.

16. The method of claim 11, wherein said measuring comprises measuring a surface coverage of the printed image.

17. A method of controlling a printed image produced by a printing apparatus, the method comprising:
a) generating a test pattern from one or more printheads of the printing apparatus wherein the printing apparatus includes;
i) an ink-jet for dispensing droplets of ink comprising a carrier liquid and a print material; and
ii) a thermal-jet including micro-structures for receiving the droplets of ink, wherein the thermal-jet is configured to heat through a temperature profile for evaporating the carrier liquid from the ink within the micro-structures and for vaporizing the print material from the micro-structures and directing the vaporized print material onto a substrate to produce the test pattern;
b) measuring a quantity of the test pattern; and
c) adjusting an output from one or more printheads on the printing apparatus based on the measured quantity of the test pattern.
